(19) United States
(12) Patent Application Publication
(10) Pub. No.: US 2026/0362088 A1
(43) Pub. Date: Nov. 12, 2026

(54) ADAPTIVE REPORTING FOR TYPE-A AND TYPE-B POSITIONING MEASUREMENT IN AIML FRAMEWORK

(71) Applicant: Nokia Technologies Oy, Espoo (FI)

(72) Inventors: Dileep KUMAR, Espoo (FI); Muhammad Ikram ASHRAF, Espoo (FI); Gilsoo LEE, Naperville, IL (US); Fahad SYED MUHAMMAD, Massy (FR)

(21) Appl. No.: 19/653,700

(22) Filed: Apr. 21, 2026

Related U.S. Application Data
(60) Provisional application No. 63/802,754, filed on May 9, 2025.

(51) Int. Cl. H04W 4/029; H04W 24/10

(52) U.S. Cl. CPC H04W 4/029; H04W 24/10

(57) ABSTRACT

A method is provided that includes receiving a reporting configuration for reporting multipath channel measurements performed on a reference signal for positioning. The method includes performing the multipath channel measurements on the reference signal for a reporting instance, the multipath channel measurements including a set of measurement samples for at least one time instance. The method includes performing an evaluation of at least one of the multipath channel measurements relative to earlier multipath channel measurements for a preceding reporting instance, or measurement samples in the set of measurement samples. And the method includes reporting, in the reporting instance based on the evaluation, an indication that the multipath channel measurements have at least a threshold similarity to the earlier multipath channel measurements, or a measurement report including a subset of the measurement samples.

### TECHNOLOGICAL FIELD

The present disclosure relates generally to telecommunications and, in particular, to measurement reporting in a telecommunications system.

### BACKGROUND

Telecommunications systems can be seen as facilities that enable communications between two or more entities such as between two user equipment, between a user equipment and a base station, between two base stations, a user equipment and a network function of a communication network and/or a base station and other nodes. A telecommunications system can include a communication network and one or more user equipment. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a telecommunications system that includes a wireless communication network, at least a part of a communication session between at least two stations occurs over a wireless link. Examples of wireless communication networks comprise public land mobile networks (PLMN), satellite-based communication networks and different wireless local networks, for example wireless local area networks (WLAN). Some wireless communication networks can be divided into cells, and are therefore often referred to as cellular networks.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by, for example, a base station of a cell, and transmit and/or receive communications on the carrier.

Telecommunications systems have evolved through multiple generations, each bringing advancements in speed, capacity, and functionality. The Evolved Packet System (EPS) represents the 4G architecture, which includes Long-Term Evolution (LTE) and LTE-Advanced (LTE-A) as its radio access technologies. The 5G System (5GS) builds upon EPS, introducing 5G New Radio (5G NR) for enhanced mobile broadband, massive machine-type communications, and ultra-reliable low-latency communications. The future 6G System (6GS) is expected to further revolutionize telecommunications with even more advanced capabilities. These systems are interconnected, with 5GS designed to interwork with EPS for seamless service continuity. The 3rd Generation Partnership Project (3GPP) plays a crucial role in developing and maintaining standards for these telecommunications systems, ensuring global interoperability and evolution from Universal Mobile Telecommunications System (UMTS) (3G) through to the ongoing development of 6G technologies.

### BRIEF SUMMARY

Example implementations of the present disclosure are directed to telecommunications and, in particular, to measurement reporting in a telecommunications system. The present disclosure includes, without limitation, the following example implementations.

Some example implementations provide an apparatus comprising: at least one memory configured to store instructions; and at least one processing circuitry configured to access the at least one memory, and execute the instructions to cause the apparatus to at least: receive a reporting configuration for reporting multipath channel measurements performed on a reference signal for positioning; perform the multipath channel measurements on the reference signal for a reporting instance, the multipath channel measurements including a set of measurement samples for at least one time instance; perform an evaluation of at least one of the multipath channel measurements relative to earlier multipath channel measurements for a preceding reporting instance, or measurement samples in the set of measurement samples; and report, in the reporting instance based on the evaluation, an indication that the multipath channel measurements have at least a threshold similarity to the earlier multipath channel measurements, or a measurement report including a subset of the measurement samples.

Some example implementations provide a method comprising: receiving a reporting configuration for reporting multipath channel measurements performed on a reference signal for positioning; performing the multipath channel measurements on the reference signal for a reporting instance, the multipath channel measurements including a set of measurement samples for at least one time instance; performing an evaluation of at least one of the multipath channel measurements relative to earlier multipath channel measurements for a preceding reporting instance, or measurement samples in the set of measurement samples; and reporting, in the reporting instance based on the evaluation, an indication that the multipath channel measurements have at least a threshold similarity to the earlier multipath channel measurements, or a measurement report including a subset of the measurement samples.

Some example implementations provide an apparatus comprising: at least one memory configured to store instructions; and at least one processing circuitry configured to access the at least one memory, and execute the instructions to cause the apparatus to at least: configure a reporting entity with a reporting configuration for reporting multipath channel measurements performed on a reference signal for positioning, the measuring node configured to perform the multipath channel measurements on the reference signal for a reporting instance, the multipath channel measurements including a set of measurement samples for at least one time instance; receive from the reporting entity an indication that the multipath channel measurements have at least a threshold similarity to earlier multipath channel measurements for a preceding reporting instance, or a measurement report including a subset of the measurement samples; recover the multipath channel measurements for the reporting instance based on the indication or the measurement report; and perform an evaluation of the reporting configuration based on the multipath channel measurements as recovered.

Some example implementations provide a method comprising: configuring a reporting entity with a reporting configuration for reporting multipath channel measurements performed on a reference signal for positioning, the measuring node configured to perform the multipath channel measurements on the reference signal for a reporting instance, the multipath channel measurements including a set of measurement samples for at least one time instance; receiving from the reporting entity an indication that the multipath channel measurements have at least a threshold similarity to earlier multipath channel measurements for a preceding reporting instance, or a measurement report including a subset of the measurement samples; recovering the multipath channel measurements for the reporting instance based on the indication or the measurement report; and performing an evaluation of the reporting configuration based on the multipath channel measurements as recovered.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. The present disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a PLMN, according to some example implementations;

FIG. 3 illustrates time-domain channel samples and sub-samples, according to some example implementations;

FIG. 4 is a diagram of a procedure for sample-based measurement reporting, according to some example implementations;

FIG. 5 is a diagram of a procedure for sample-based measurement reporting, according to some other example implementations;

FIGS. 6A, 6B and 6C are flowcharts illustrating various steps in a method according to various example implementations;

FIGS. 7A, 7B and 7C are flowcharts illustrating various steps in a method according to various example implementations; and

FIG. 8 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout. Unless specified otherwise or clear from context, references to first, second or the like should not be construed to imply a particular order but are merely utilized to distinguish one item or operation from another.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

The present disclosure discusses telecommunication systems and mobile or cellular networks and user equipment thereof, and while specific terms may be used, are broadly applicable across various technologies. For instance, while the present disclosure may reference radio access technologies such as 5G NR and 5G Advanced, the present disclosure is equally relevant to next generation radio access technologies, such as 6G. Example implementations of the present disclosure described herein also mention public land mobile networks (PLMNs) and mobile network operators (MNOs), but example implementations are similarly applicable to standalone non-public networks (SNPNs).

Although some examples and figures focus on radio access networks (RANs) and in particular radio access networks that operate in accordance with the 3GPP standard for 5G NR (generally referred to as 3GPP access or 3GPP access networks), example implementations are applicable to any type of access networks. The applicability to any type of access network includes not only 3GPP access networks but also non-3GPP access networks, such as wireline access, untrusted non-3GPP access network, and trusted non-3GPP access network using wireless access gateway function (W-AGF), non-3GPP interworking function (N3IWF), or trusted non-3GPP gateway function (TNGF) to connect to a core network (e.g., a 5G core network (5GC) or a 6G core network (6GC)) of a mobile or cellular network.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

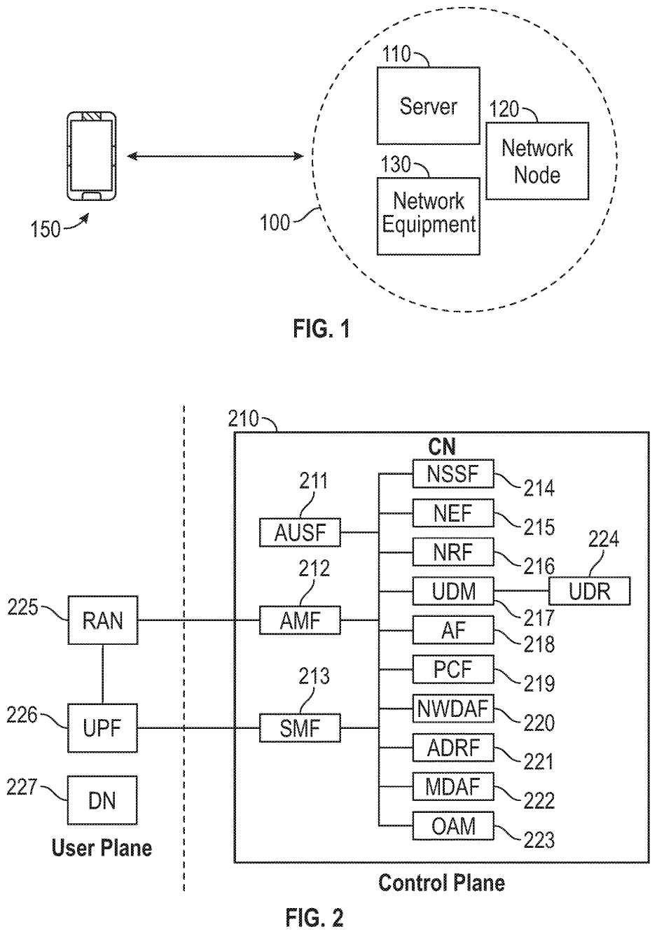

FIG. 1 illustrates a telecommunications system 100 according to various example implementations of the present disclosure. Examples of suitable telecommunications systems include UMTS, EPS and 5GS, as well as the future 6GS. The telecommunications system (otherwise referred to as a system) generally includes one or more mobile or cellular networks, and these mobile or cellular networks may interwork between telecommunications systems. As shown, for example, the system includes one or more PLMNs 102 coupled to one or more other external data networks 104—notably including a wide area network (WAN) such as the Internet. As will be appreciated, a PLMN may be a standalone PLMN that includes a 5GC, or may be a non-standalone PLMN that includes both an Evolved Packet Core (EPC) and a 5GC connected to a RAN.

Each of the PLMNs 102 includes a core network (CN) 106, such as the EPC, the 5GC, or a 6GC; and each CN is coupled to one or more RANs 108 that implement one or more radio access technologies (RATs). Examples of these RANs include the evolved UMTS terrestrial radio access network (E-UTRAN) of 4G LTE, the next generation (NG) radio access network (NG-RAN) of 5G NR, and the 6G RAN. As used herein, a “network device” refers to any suitable device of a RAN or a core network of a telecommunications system. Examples of suitable network devices are described in greater detail below.

Examples of RATs include 3GPP radio access technologies such as GSM, CDMA2000 1×EV-DO (HRPD), CDMA2000 1× (1×RTT), UTRA, E-UTRA, 5G NR, 5G Advanced, and 6G. Other examples of RATs include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a RAT may refer to any 2G, 3G, 4G, 5G, 6G or higher generation RAT and their different versions, as well as to any other RAT that may be arranged to interwork with such a RAT to provide access to the CN 106 of a MNO.

The telecommunications system 100 also includes one or more communication devices that may be varyingly known as user equipment (UE) 110, terminal device, terminal equipment, mobile station or the like. The UE is generally a device configured to communicate with a network device (e.g., an access node such as a RAN node of RAN 108) or a or a further UE in the telecommunications system. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIoT device), a vehicle equipped with a vehicle-to-everything (V2X) communication technology, or the like. In some examples, as referenced by 3GPP, the UE may be a narrowband IoT (NB-IoT) device, an enhanced machine-type communication (eMTC) device, a reduced capability (RedCap) device, an ambient IoT device, or the like.

In operation, these UEs 110 may connect to one or more RAN nodes of the RANs 108 according to their particular RATs to thereby access a particular CN 106 of a PLMN 102, or to access one or more of the external data networks 104 (e.g., the Internet) or services provided by the PLMN. The external data network may provide Internet access, or 3rd party services. For example, the International Telecommunication Union (ITU) has classified 5G mobile network services (e.g., services provided by a 5G mobile network) into three categories: enhanced mobile broadband (eMBB), ultra-reliable and low-latency communications (URLLC), and massive machine type communications (mMTC) or massive internet of things (MIoT).

In various examples, a RAN 108 may be configured to provide one or more macrocells, microcells, picocells, femtocells or the like. The RAN may generally include one or more RAN nodes that interact with UEs 110. In various examples, a RAN node may be referred to as a base station (BS), access point (AP), base transceiver station (BTS). Examples of RAN nodes include a Node B (NB), evolved NB (eNB), macro BS, NB (MNB) or eNB (MeNB), home BS, NB (HNB) or eNB (HeNB), next generation NB (gNB), enhanced gNB (en-gNB), next generation eNB (ng-eNB), 6G NB (6gNB), or the like. The term ‘gNB’ in 5G NR may correspond to the eNB in 4G LTE. Also, a NG-RAN node may refer to a gNB or a ng-eNB. And unless otherwise specified, a gNB in 5G NR or a 6gNB in 6G may at times be more generally referred to as a (6)gNB or more simply a gNB.

The RAN 108 may include some type of network controlling/governing entity responsible for control of the RAN nodes. The network controlling/governing entity and RAN node may be separate or integrated into a single apparatus. The network controlling/governing entity may include processing circuitry configured to carry out various management functions for controlling RAN nodes of the RAN. The processing circuitry may be associated with a memory, computer-readable storage medium or a data storage device comprising a database for maintaining information required in the various management functions.

FIG. 2 illustrates an example of a PLMN 102, such as 4G LTE, 5G NR or 6G PLMN that communicates with a UE 110 and an external data network 104 of the telecommunications system 100. As shown, the RAN 108 (e.g., E-UTRAN, NG-RAN, 6G RAN) includes one or more RAN nodes 202 configured to connect one or more UEs to the RAN to thereby access the CN 106 (e.g., EPC, 5GC, 6GC). In 4G LTE, the UE, E-UTRAN and EPC compose EPS. Similarly, in 5G NR, the UE, NG-RAN and 5GC compose the 5GS. And in 6G, the UE, 6G RAN and 6GC compose the 6GS.

In some implementations, operations of a gNB or other RAN node may be distributed or functionally split into components including one or more remote radio head (RRHs) or radio units (RUs), and a baseband unit (BBU); and in some implementations, the BBU may be split into a central/centralized unit (CU) (central node) and a distributed unit (DU) (distributed node). The CU may be, for example, a server, host or node. In some implementations, the RRH/RU and DU may be collocated at a network device. It is also possible that operations of a gNB or RAN node may be distributed among a plurality of servers, hosts or nodes.

It should also be understood that the distribution of work between core network operations and RAN node operations may vary depending on implementation. A 5G or 6G network architecture, for example, may be based on a so-called CU-DU split. One gNB-CU (a CU 204) may control one or more gNB-DUs (DUs 206). The gNB-CU may control a plurality of spatially separated gNB-DUs, acting at least as transmit/receive (Tx/Rx) nodes. In some example implementations, however, the gNB-DUs may include, for example, a radio link control (RLC), medium access control (MAC) layer and a physical (PHY) layer, whereas the gNB-CU may include the layers above the RLC layer, such as a packet data convergence protocol (PDCP) layer, a radio resource control (RRC), and an internet protocol (IP) layer. Other functional splits are also possible. It is considered that skilled person is familiar with the open systems interconnection (OSI) model and the functionalities within each layer.

In some example implementations, the server or CU 204 may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU 206, and the boundary where the responsibility is shifted between the CU and the DU may be selected according to implementation.

Although not separately shown, the CN 106 may include a number of network functions (NFs) divided between the control plane (CP) and the user plane (UP). In particular, for example, the CN may include, for example, NFs for access and mobility management (MM) and session management (SM), such as an access and mobility management function (AMF) and a session management function (SMF) in the 5GS. The NFs may include an NF for reception and transmission of traffic (e.g., data), such as a user plane function (UPF) in 5GS/6GS. As another example, the CN may include a location management function (LMF) 208 or other NF for co-ordination and scheduling of resources required for the location of the UE 110.

A more recent study item in 3GPP is focused on the use of artificial intelligence (AI)/machine learning (ML) technologies and algorithms for enhanced performance and/or reduced complexity/overhead by cementing the foundation for future air-interface use cases. Initial use cases under investigation include channel state information (CSI) feedback enhancement (e.g., overhead reduction, improved accuracy), beam management (e.g., beam prediction in time, and/or spatial domain for overhead and latency reduction), positioning accuracy enhancements, and mobility.

The study item on positioning accuracy enhancements through AI/ML for the air interface aims to aims to improve the precision of UE location estimation. The study item encompasses direct AI/ML positioning and AI/ML-assisted positioning. Direct AI/ML positioning targets a number of cases, including UE-based positioning with UE-side model, direct AI/ML positioning (case 1), UE-assisted/LMF-based positioning with LMF-side model, direct AI/ML positioning (case 2b), and RAN node-assisted positioning with LMF-side model, direct AI/ML positioning (case 3b). AI/ML-assisted positioning involves cases targets cases, including UE-assisted/LMF-based positioning with UE-side model, AI/ML-assisted positioning (case 2a), and RAN node-assisted positioning with gNB-side model, AI/ML-assisted positioning (case 3a).

Some of the cases (case 2b, case 3b) targeted by the study item on positioning accuracy enhancements through AI/ML include an LMF-side model; and accordingly, these cases involve measurement reporting to the LMF 208. In these cases, the power information is used to determine the model input of the LMF-side model. In particular, downlink (DL) positioning reference signal (PRS)-reference signal received power per path (RSRPP) is used for DL power measurement, and uplink (UL) sounding reference signal (SRS)—RSRPP is used for UL power measurement.

For example, a report mapping table for SRS-RSRPP in the current standard specification is defined with the reporting range of UL SRS RSRPP from −156 dBm to −31 dBm with a resolution 1 dB, and the mapping of measured quantity. For instance, below is a part of the mapping table where the reported values from SRS RSRPP 4 to SRS_RSRPP_126 are omitted.

| Reported value | Measured quantity value | Unit |
|---|---|---|
| SRS_RSRPP_0 | SRS-RSRPP < −156 | dBm |
| SRS_RSRPP_1 | −156 ≤ SRS-RSRPP < −155 | dBm |
| SRS_RSRPP_2 | −155 ≤ SRS-RSRPP < −154 | dBm |
| SRS_RSRPP_3 | −154 ≤ SRS-RSRPP < −153 | dBm |
| (omitted) | (omitted) | (omitted) |

AI/ML-based positioning case 3b can use sample-based measurement with an existing definition of two channel measurement types called type A and type B. In this regard, measurement type A is used for path-based measurements; measurement type B is used for sample-based measurements. Descriptive information of the channel measurement includes at least the measurement type A or type B, and measurement parameters. For measurement type A (path-based measurement), the measurement parameters include a number of additional paths, k. For measurement type B (signal-based measurement), the measurement parameters include a number Nₜ′ of samples in the measurement, and k.

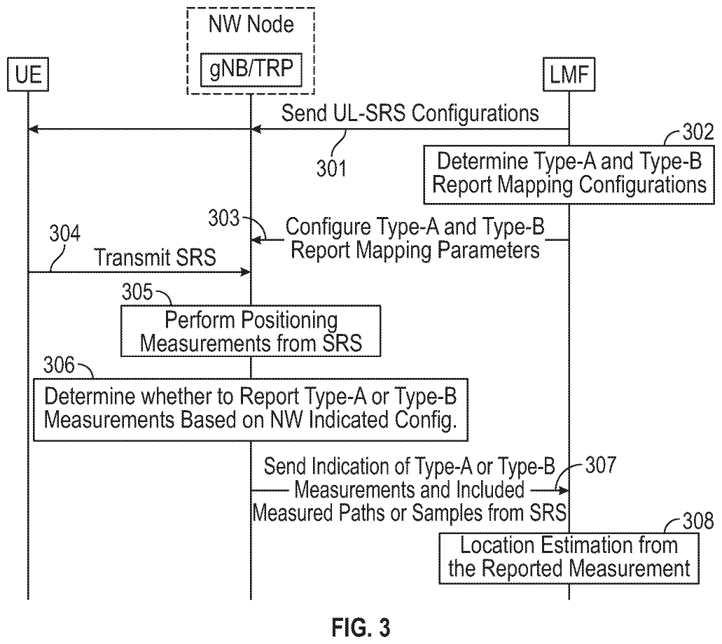

For model input used in at least some evaluations of AI/ML-based positioning, the input dimension for measurements is N_{TRP}*Nₚₒᵣₜ*Nₜ, where N_{TRP} is the number of TRPs, Nₚₒᵣₜ is the number of transmit/receive antenna port pairs, and Nₜ is the number of consecutive time domain samples. If N′ₜ (N′ₜ<Nₜ) samples with the strongest power are selected as the model input, with remaining (Nₜ−N′ₜ) time domain samples set to zero, it is assumed that timing info for the N′ₜ samples need to be provided as model input. FIG. 3 illustrates a proposal for time-domain channel samples Nₜ and subsamples N′ₜ that follows a heuristic approach.

Path-based (type A) measurements focus on identifying and reporting specific signal paths of a multipath channel, particularly the first path and any additional paths detected during channel measurement. Sample-based (type B) measurements, instead of focusing on specific paths, capture time-domain samples of the channel impulse response (CIR). Sample-based measurements therefore include measurement samples for one or more time instances.

Relative to path-based measurements, sample-based measurements offer a denser representation of a multipath channel by capturing sequential time-domain samples. Specifically considering the case 3b or case 2b that involve an LMF-side model, a large number of samples may need to be reported for the purpose of data collection. Furthermore, in scenarios where the channel measurements (Type A/B) remain stable over several time slots, such as with a static UE 110, the measurement is likely to remain valid for an extended duration. Consequently, frequent reporting of channel measurement in this situation is unnecessary and leads to an inefficient use of network resources, resulting in increased overhead.

In view of the foregoing, example implementations of the present disclosure provide solution(s) for sample-based measurement reporting, particularly targeting type B measurement. As described herein, these multipath channel measurements may at times be referred to as UL reference signal received sample power (RSRSP), or more simply as measurements. The solution(s) of some example implementations involve a reporting entity and an LMF 208. In various examples, the reporting entity may be a UE 110 or a transmission-reception point (TRP). In various examples, a TRP may be a RAN node 202 (e.g., gNB, ng-eNB), RAN node antenna, antenna array or panel, RRHs, RUs, a remote antenna, antenna array or panel of a RAN node, or the like.

As described in greater detail below, according to some examples, the LMF 208 may configure the reporting entity (e.g., UE 110, RAN node 202 or other TRP) with a reporting configuration for reporting measurements (RSRSP) performed on a reference signal for positioning (e.g., PRS, SRS). The reporting configuration may include, for example, information that indicates a measurement type (e.g., type A, type B), a maximum number of measurement samples which may be reported, and/or sensitivity threshold for reporting measurement samples. Additionally or alternatively, for example, the reporting configuration may include information indicating a report periodicity, methods and/or resources for reporting measurements.

The reporting entity (e.g., UE 110, RAN node 202 or other TRP) may perform the measurements which may include a set of measurement samples for at least one time instance. In some examples, the reporting entity may choose a reporting configuration based on the set of measurement samples. The reporting entity may perform an evaluation of the measurements relative to earlier measurements for a preceding reporting instance, and/or measurement samples in the set of measurement samples. Based on the evaluation, the reporting entity may in some examples report to the LMF 208, in the reporting instance, an indication that the measurements have at least a threshold similarity to the earlier measurements. In some other examples, the reporting entity may report a measurement report including a subset of the measurement samples.

In some examples, the evaluation indicates the measurements have at least a threshold similarity to the earlier measurements. For instance, two measurements at two consecutive times may be determined to be correlated or identical to each other, such as based on a similarity score (e.g., Gaussian similarity, cosine similarity), while obeying the sensitivity threshold in the reporting configuration. In these examples, the reporting entity (e.g., UE 110, RAN node 202 or other TRP) may report the indication in the reporting instance without any measurement samples from the set of measurement samples. This indication may include, for example, a status, flag or the like, which may represent that the latest measurement is similar to or the same as previously reported measurements.

In some other examples, the evaluation indicates the measurements do not have at least a threshold similarity to the earlier measurements. In these other examples, the reporting entity may report the measurement report including the subset of the measurement samples may be reported in the reporting instance. The subset of the measurement samples may be selected in a number of different manners, such as based the sensitivity threshold in the reporting configuration.

In some examples in which the measurement report is to be reported, the reporting entity (e.g., UE 110, RAN node 202 or other TRP) may select the subset of the measurement samples that is fewer in number than the set of the measurement samples, and prepare the measurement report including the subset of the measurements. For instance, if Nₜ′=10, the measurement samples may include measured power values of the first, second, . . . , and tenth samples. The measurement report may also include information that indicates how the subset of the measurement samples was selected, which may be used by the LMF 208 to recover the set of measurement samples. For each measurement sample of at least some of the measurement samples, for example, the reporting entity may calculate a sample value difference between values for the measurement sample and an earlier measurement sample from the earlier measurements. The reporting entity may then select one or multiple measurement samples to compose the subset of the measurement samples when the sample value difference is greater than a threshold difference.

In some examples, the reporting entity (e.g., UE 110, RAN node 202 or other TRP) may perform a mapping of measured values for the measurement samples in the subset to reported values, which may then be included in the measurement report. In some examples, the mapping tables with the format used in 3GPP TS 38.133 for RSRPP may be used. In some other examples, the mapping may be defined in a mapping table applicable to sample-based measurements including the measurement samples, which may in some cases be dedicated to sample-based measurements. In yet some other examples, the mapping may be defined in a mapping table for path-based measurements which is extended to include sample-based measurements including the measurement samples.

The LMF 208 may receive the indication or the measurement report from the reporting entity, and recover the measurements for the reporting instance based on the indication or the measurement report. In some examples in which the indication is reported by the reporting entity, the LMF may recover the measurements based on the earlier measurements. In other examples in which the measurement report is reported, the LMF may recover the measurements based on the subset of the measurement samples in the measurement report, and earlier measurement samples from the earlier measurements.

The LMF 208 may perform an evaluation of the reporting configuration based on the measurements as recovered. In some examples in which the reporting entity is located at a reference location, in the evaluation, the LMF may determine a location of the reporting entity based on the measurements as recovered. The LMF may perform a comparison of the location of the reporting entity and the reference location, and then perform the evaluation of the reporting configuration based on the comparison. In some further examples, then, the LMF may further perform an update to the reporting configuration based on the evaluation, and configure the reporting entity with the update to the reporting configuration.

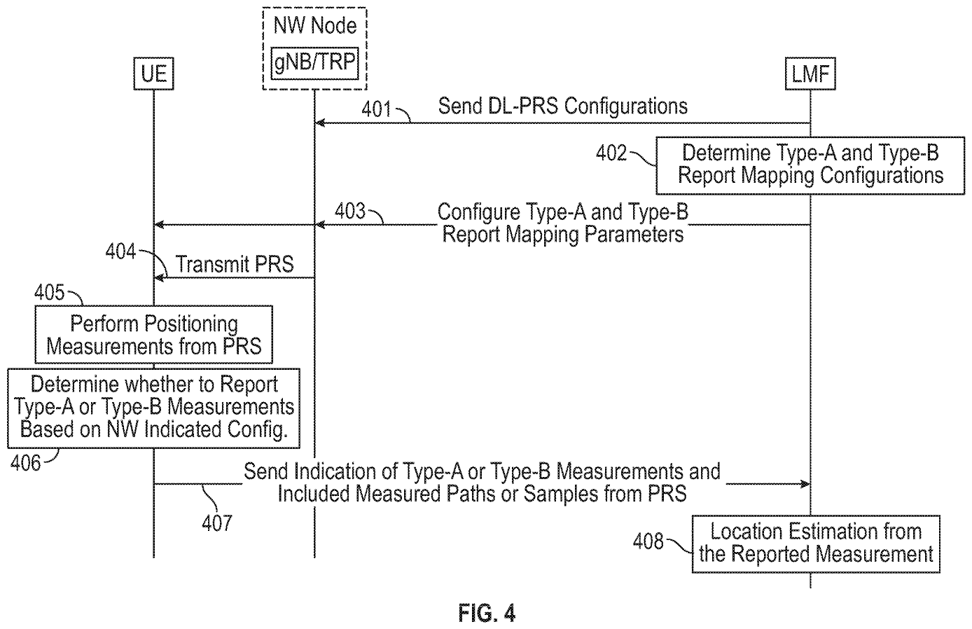

To further illustrate some example implementations, FIG. 4 is a diagram of a procedure for sample-based measurement reporting in which a RAN node 202 (or other TRP) is the reporting entity. As shown, the LMF 208 may at step 401 send an SRS configuration a UE 110 via the RAN node. The LMF may at steps 402, 403 determine a reporting configuration for reporting sample-based measurements (i.e., multipath channel measurements including measurement samples for at least one time instance), and send the reporting configuration to the RAN node to configure the RAN node with the reporting configuration. As indicated above, the reporting configuration may include, for example, information that indicates a measurement type (e.g., type A, type B), a maximum number of measurement samples which may be reported, a sensitivity threshold for reporting measurement samples. The reporting configuration may also include, for example, information indicating a report periodicity, methods and/or resources for reporting measurements.

The UE 110 may step 404 transmit SRS based on the SRS configuration, and the RAN node 202 may at step 405 perform measurements on the SRS for a reporting instance, such as according to a periodicity indicated in the reporting configuration. The measurements include a set of measurement samples for at least one time instance. The RAN node 202 may at step 406 perform an evaluation of the measurements and/or measurement samples to determine whether to send a new measurement report or indicate similarity of the measurements to earlier measurements which may have been reported to the LMF 208 in an earlier measurement report (in an earlier reporting instance). When the measurements have at least a threshold similarity to the earlier measurements, the RAN node may at step 407 report, to the LMF, a corresponding indication. In this regard, the RAN node may indicate the measurement samples are the same as or similar to measurement samples in the earlier measurement report, which may indicate the earlier measurement report remains valid.

When the measurements do not have at least a threshold similarity to the earlier measurements, the RAN node 202 may at step 408 select a subset of the measurement samples to be included in the report. For a measurement sample, for example, the RAN node may calculate a sample value difference between values for the measurement sample and an earlier measurement sample, and select the measurement sample when the sample value difference is greater than a threshold difference. The sample value difference may be defined as the absolute difference between a current measurement sample value and an earlier measurement sample in the earlier measurement report.

In comparing the measurements for purposes of the threshold similarity, measurement samples may be compared to earlier measurement samples in the same order. For instance, the first measurement sample in the subset (Nₜ′) of measurement samples to be reported may be compared to the first measurement sample in the earlier measurement report. Alternatively, the measurement samples may be compared to the earlier measurement samples in a different order. For instance, the second measurement sample in the subset (Nₜ′) of measurement samples to be reported may be compared to the first or third measurement sample in the earlier measurement report. In this case, the maximum difference in order (or rank) is one. In other examples in which the maximum difference is two, the second measurement sample in the subset (Nₜ′) of measurement samples to be reported may be compared to the first, third or fourth measurement sample in the earlier measurement report. In some examples, a maximum difference in order (or rank) within a set of measurement samples may be predefined or configured by the RAN 108.

Regardless of how the subset of the measurement samples is selected for the measurement report, the RAN node 202 may at step 409 send, to the LMF 208, the measurement report including the subset of the measurement samples.

The LMF 208 may receive the indication (at step 407) or the measurement report (at step 409), and recover the measurements for the reporting instance based on the indication/measurement report.

In some examples, the LMF may at step 410 perform an evaluation of the reporting configuration based on the measurements as recovered. In some examples, the RAN node 202 is located at a reference location, such as the location of a positioning reference unit (PRU). In these examples, the LMF may determine the location of the RAN node based on the measurements as recovered, and compare the location of the RAN node and the reference location. When the location of the RAN node and the reference location differ by more than a threshold that indicates degraded positioning accuracy, the LMF may update the reporting configuration. For instance, LMF may decrease the value of the threshold that is used to determine whether to send a new measurement report so that the LMF may receive a report with more up-to-date measurement samples. The LMF may at step 411 send the updated reporting configuration to the RAN node to configure the RAN node with the update.

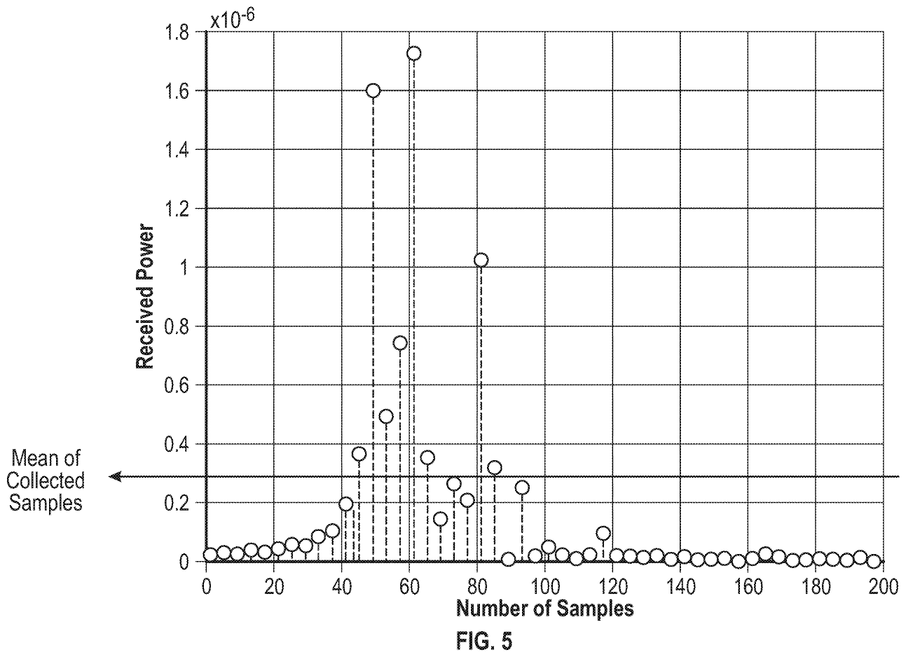

FIG. 5 is a diagram of a procedure for sample-based measurement reporting in which a UE 110 is the reporting entity. The procedure is similar to that described above in which the RAN node 202 (or other TRP) is the reporting entity; and accordingly, the following description of the procedure focuses more on differences between the procedures. As shown in FIG. 5, the LMF 208 may at step 501 send an PRS configuration to the RAN node 202 (or other TRP). The LMF may at steps 502, 503 determine a reporting configuration for reporting sample-based measurements (i.e., multipath channel measurements including measurement samples for at least one time instance), and send the reporting configuration to the UE 110 (via the RAN node) to configure the UE with the reporting configuration. The reporting configuration may be the same as or similar to that described above.

The RAN node 202 may step 504 transmit PRS based on the PRS configuration, and the UE 110 may at step 505 perform measurements on the PRS for a reporting instance, such as according to a periodicity indicated in the reporting configuration. The measurements include a set of measurement samples for at least one time instance.

The UE 110 may at step 506 perform an evaluation of the measurements and/or measurement samples to determine whether to send a new measurement report or indicate similarity of the measurements to earlier measurements which may have been reported to the LMF 208 in an earlier measurement report (in an earlier reporting instance). When the measurements have at least a threshold similarity to the earlier measurements, the UE may at step 507 report, to the LMF (via the RAN node 202), a corresponding indication. In this regard, the UE may indicate the measurement samples are the same as or similar to measurement samples in the earlier measurement report, which may indicate the earlier measurement report remains valid.

When the measurements do not have at least a threshold similarity to the earlier measurements, the UE 110 may at step 508 select a subset of the measurement samples to be included in the report. For a measurement sample, for example, the UE may calculate a sample value difference between values for the measurement sample and an earlier measurement sample, and select the measurement sample when the sample value difference is greater than a threshold difference. The sample value difference may be defined as the absolute difference between a current measurement sample value and an earlier measurement sample in the earlier measurement report. In comparing the measurements for purposes of the threshold similarity, measurement samples may be compared to earlier measurement samples in the same order or in a different order, as described above.

Regardless of how the subset of the measurement samples is selected for the measurement report, the UE 110 may at step 509 send, to the LMF 208 (via the RAN node 202), the measurement report including the subset of the measurement samples.

The LMF 208 may receive the indication (at step 507) or the measurement report (at step 509), and recover the measurements for the reporting instance based on the indication/measurement report.

In some examples, the LMF may at step 510 perform an evaluation of the reporting configuration based on the measurements as recovered. In some examples, the UE 110 is located at a reference location, such as the location of a PRU. In these examples, the LMF may determine the location of the UE based on the measurements as recovered, and compare the location of the UE and the reference location. When the location of the UE and the reference location differ by more than a threshold that indicates degraded positioning accuracy, the LMF may update the reporting configuration. For instance, LMF may decrease the value of the threshold that is used to determine whether to send a new measurement report so that the LMF may receive a report with more up-to-date measurement samples. The LMF may at step 511 send the updated reporting configuration to the UE (via the RAN node 202) to configure the UE with the update.

As indicated above, the report mapping for RSRPP is currently defined from −156 dBm to −31 dBm with a resolution 1 dB. In some examples, the reporting entity (e.g., UE 110, RAN node 202 or other TRP) may perform a similar mapping for RSRSP. In some of these examples, the mapping tables similar to one defined for RSRPP may be used. The mapping for RSRSP may enable the reporting entity to represent a more fine-grained measurement approach, capturing individual time-domain samples rather than aggregated path-based power (which can be limited to eight paths). In some other examples, then, the mapping of RSRSP may be defined in a mapping table applicable to sample-based measurements, or a mapping table for path-based measurements may be extended to include sample-based measurements.

In one option, a dedicated RSRSP mapping table may be used for sample-based (type B) measurement reporting. This mapping table may be similar to the existing RSRPP table, but tailored for more granular (and dense) time-domain samples of sample-based measurements. In some more particular examples, the RSRSP mapping may defines a dedicated measurement reporting range and granularity/resolution between two consecutive entries of the table which captures the power level of an individual sample. As an example, the resolution for sample-based measurements may be higher [0.1-0.25] dB to maintain fine granularity (e.g., for each path, 4-10 samples may be captured) and avoid excessive quantization errors.

In another, second option, the RSRPP mapping table may be extended to support sample-based measurement reporting. The standardized mapping for SRS-RSRPP, for example, includes the values ranging from −156 dBm to −31 dBm with a resolution of 1 dB. To accommodate additional sample-based measurement reporting, the RSRPP mapping table may be extended with finer resolution, such 0.25 dB, so that individual time-domain samples of RSRSP measurements may be captured with some accuracy. Below illustrates an example involving a subdivision of the RSRPP mapping table in which a reported value with additional bits may represent a more granular measurement sample.

| | Measured | | | |
|---|---|---|---|---|
| Reported | Quantity Value | Measured Quantity | | |
| Value | (Path-Based) | Value (Sample-Based) | | Unit |
| RSRPP_1 | −156 ≤ | RSRPP_1_0 | −156 ≤ | dBm |
| | SRS-RSRPP < | | SRS-RSRPP < | |
| | −155 | | −155.75 | |
| | | RSRPP_1_1 | −155.75 ≤ | |
| | | | SRS-RSRPP < | |
| | | | −155.50 | |
| | | RSRPP_1_2 | −155.50 ≤ | |
| | | | SRS-RSRPP < | |
| | | | −155.25 | |
| | | RSRPP_1_3 | −155.25 ≤ | |
| | | | SRS-RSRPP < | |
| | | | −155 | |

In this second option, a scaling factor (e.g., 0.25 dB) may be provided to differentiate between path-based (RSRPP) and sample-based (RSRSP) power levels, which may ensure compatibility of RSRSP reports with legacy RSRPP reports. Also, in some examples involving this option, the measurement report may be extended to include information indicating a maximum number of measurement samples in the measurement report corresponding to each path represented in the table. For example, the measurement report may be extended by two bits to indicate a maximum of four measurement samples in the measurement report corresponding to each path represented in the table.

In another, third option, an order of paths may determine which RSRPP mapping table is applied for sample-based measurement reporting. Suppose that multiple report mapping tables are predetermined. For instance, the mapping tables may have different granularities and/or ranges. In this case, a measurement report for reporting the first path may use one of the tables that has the highest resolution to enhance the positioning accuracy. The second path reporting may use the same table or another table that has a lower resolution to reduce the reporting overhead. In some examples involving this option, the LMF 208 may determine the report mapping in step 402/502, and indicated in the reporting configuration at step 403/503. In some other examples, the determination may be performed by the RAN node 202/UE 110 (the reporting entity) in step 408/508 based on available information, such as raw data acquired from the SRS/PRS measurements.

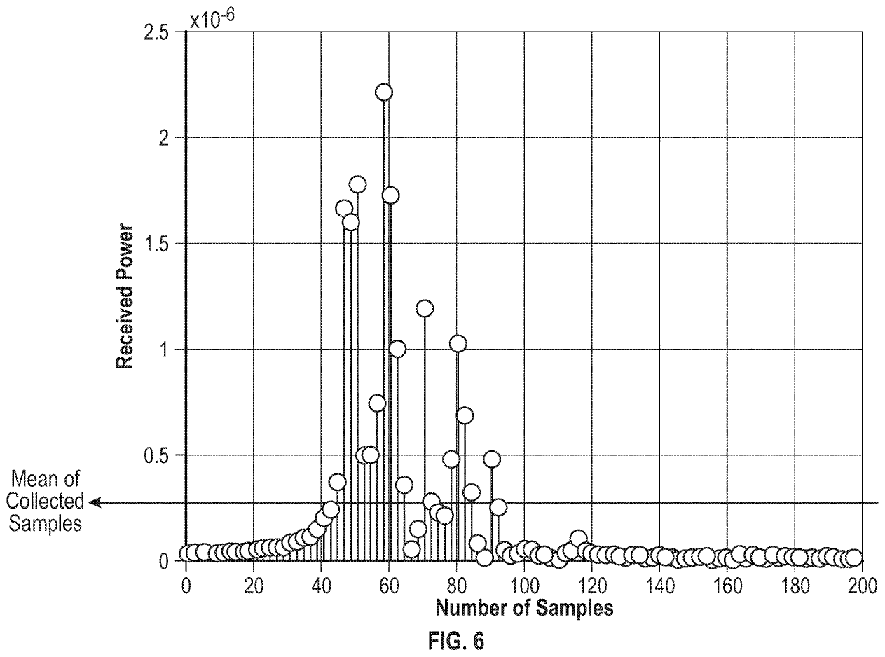

FIGS. 6A-6C are flowcharts illustrating various steps in a method 600 according to various example implementations. The method includes receiving a reporting configuration for reporting multipath channel measurements performed on a reference signal for positioning, as shown at block 602 of FIG. 6A. The method includes performing the multipath channel measurements on the reference signal for a reporting instance, the multipath channel measurements including a set of measurement samples for at least one time instance, as shown at block 604. The method includes performing an evaluation of at least one of the multipath channel measurements relative to earlier multipath channel measurements for a preceding reporting instance, or measurement samples in the set of measurement samples, as shown at block 606. And the method includes reporting, in the reporting instance based on the evaluation, an indication that the multipath channel measurements have at least a threshold similarity to the earlier multipath channel measurements, or a measurement report including a subset of the measurement samples, as shown at block 608.

In some examples, the method 600 is performed by a transmission-reception point (TRP), and the reference signal is a sounding reference signal (SRS) transmitted by a user equipment (UE).

In some examples, the method 600 is performed by a user equipment (UE), and the reference signal is a positioning reference signal (PRS) transmitted by a transmission-reception point (TRP).

In some examples, the evaluation indicates the multipath channel measurements have at least a threshold similarity to the earlier multipath channel measurements. In some of these examples, the indication is reported at block 608 in the reporting instance without any measurement samples from the set of measurement samples.

In some examples, the evaluation indicates the multipath channel measurements do not have at least a threshold similarity to the earlier multipath channel measurements. In some of these examples, the measurement report including the subset of the measurement samples is reported at block 608 in the reporting instance.

In some examples, the method 600 further includes selecting the subset of the measurement samples that is fewer in number than the set of the measurement samples, as shown at block 610 of FIG. 6B. In some of these examples, the method also includes preparing the measurement report including the subset of the measurements, as shown at block 612.

In some examples, selecting the subset of the measurement samples at block 610 includes, for each measurement sample of at least some of the measurement samples, calculating a sample value difference between values for the measurement sample and an earlier measurement sample from the earlier multipath channel measurements, as shown at block 614 of FIG. 6C. In some of these examples, selecting the subset of the measurement samples also includes selecting the measurement sample for the subset of the measurement samples when the sample value difference is greater than a threshold difference, as shown at block 616.

In some examples, the measurement report is reported at block 608. In some of these examples, the method 600 further includes performing a mapping of measured values for the measurement samples in the subset of the measurement samples to reported values for the measurement samples in the subset of the measurement samples. Also in some of these examples, the measurement report includes the reported values.

In some examples, the mapping is defined in a mapping table applicable to sample-based measurements including the measurement samples.

In some examples, the mapping is defined in a mapping table for path-based measurements which is extended to include sample-based measurements including the measurement samples.

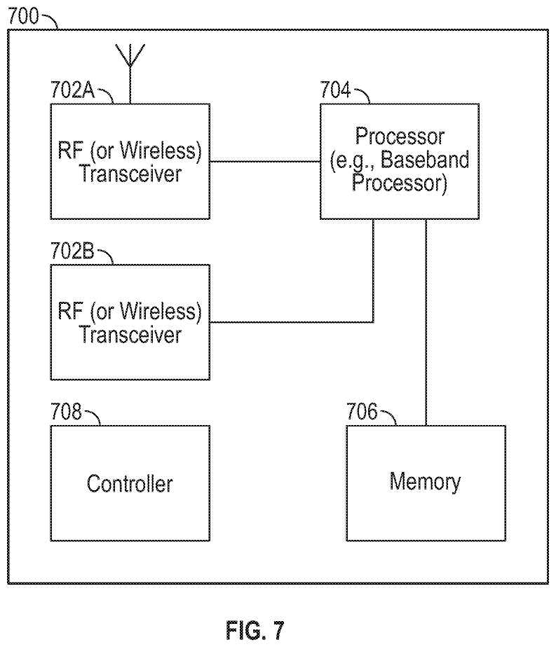

FIGS. 7A-7C are flowcharts illustrating various steps in a method 700 according to various example implementations. The method includes configuring a reporting entity with a reporting configuration for reporting multipath channel measurements performed on a reference signal for positioning, the measuring node configured to perform the multipath channel measurements on the reference signal for a reporting instance, the multipath channel measurements including a set of measurement samples for at least one time instance, as shown at block 702 of FIG. 7A. The method includes receiving from the reporting entity an indication that the multipath channel measurements have at least a threshold similarity to earlier multipath channel measurements for a preceding reporting instance, or a measurement report including a subset of the measurement samples, as shown at block 704. The method includes recovering the multipath channel measurements for the reporting instance based on the indication or the measurement report, as shown at block 706. And the method includes performing an evaluation of the reporting configuration based on the multipath channel measurements as recovered, as shown at block 708.

In some examples, the reporting entity is a transmission-reception point (TRP), and the reference signal is a sounding reference signal (SRS) transmitted by a user equipment (UE).

In some examples, the reporting entity is a user equipment (UE), and the reference signal is a positioning reference signal (PRS) transmitted by a transmission-reception point (TRP).

In some examples, the indication that the multipath channel measurements have at least the threshold similarity to earlier multipath channel measurements is received. In some of these examples, the multipath channel measurements are recovered at block 706 based on the earlier multipath channel measurements.

In some examples, the measurement report is received. In some of these examples, the multipath channel measurements are recovered at block 706 based on the subset of the measurement samples in the measurement report, and earlier measurement samples from the earlier multipath channel measurements.

In some examples, the measurement report is received at block 704. In some of these examples, and the measurement report includes reported values for the measurement samples in the subset of the measurement samples, the reported values mapped from a mapping of measured values for the measurement samples in the subset of the measurement samples.

In some examples, the mapping is defined in a mapping table applicable to sample-based measurements including the measurement samples.

In some examples, the mapping is defined in a mapping table for path-based measurements which is extended to include sample-based measurements including the measurement samples.

In some examples, the reporting entity is located at a reference location, and performing the evaluation at block 708 includes determining a location of the reporting entity based on the multipath channel measurements as recovered, as shown at block 710 of FIG. 7B. In some of these examples, performing the evaluation also includes performing a comparison of the location of the reporting entity and the reference location, as shown at block 712. And performing the evaluation includes performing the evaluation of the reporting configuration based on the comparison, as shown at block 714.

In some examples, the method 700 further includes performing an update to the reporting configuration based on the evaluation, as shown at block 716 of FIG. 7C. In some of these examples, the method also includes configuring the reporting entity with the update to the reporting configuration, as shown at block 718.

According to example implementations of the present disclosure, a telecommunications system 100 or PLMN 102, and components thereof such as UE 110, CN 106, RAN 108, RAN node 202, CU 204, DU 206, TRP 420 and/or LMF 422, may be implemented by various means. Means for implementing the system and its components may include hardware, firmware, software, or combinations thereof. In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

According to some example implementations, at least some of the method 600 described with respect to FIGS. 6A-6C may be carried out by an apparatus comprising means for performing functions corresponding steps of the method. Similarly, at least some of the method 700 described with respect to FIGS. 7A-7C may be carried out by an apparatus comprising means for performing functions corresponding steps of the method. Examples of a suitable apparatus may include a user equipment, user device, user terminal or the like. Other examples of a suitable apparatus may include a RAN node (e.g., ng-eNB, gNB, gNB-DU, gNB-CU) or any suitable apparatus, such as a server, host or node. Yet other examples of a suitable apparatus may include standalone computer comprising an LMF, such as a server, host or node, a distributed computing system comprising an LMF, or a cloud computing system comprising an LMF. The LMF may be implemented as a virtual machine or a container by a distributed computing system or a cloud computing system.

FIG. 8 illustrates an apparatus 800 in which means for performing various operations includes hardware, alone or under direction of one or more computer programs from a computer-readable storage medium or other memory, such as computer memory, according to some example implementations of the present disclosure. The apparatus may include one or more of each of a number of components such as, for example, processing circuitry 802 connected to computer-readable storage medium or other memory 804.

The processing circuitry 802 may be composed of one or more processors alone or in combination with one or more computer-readable storage media. The processing circuitry is generally any piece of computer hardware that is capable of processing information such as, for example, data, computer programs, computer code and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the memory 804 (of the same or another apparatus).

The processing circuitry 802 may comprise a number of processors, a multi-core processor or some other type of processor, such as a central processing unit, a graphics processing unit, a tensor processing, unit, or an accelerator, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more application specific integrated circuits (ASICs), field programmable gate arrays (FPGAs) or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The memory 804 is generally any piece of computer hardware that is capable of storing information such as, for example, data, computer programs, instructions 806 (e.g., computer-readable program code) and/or other suitable information either on a temporary basis and/or a permanent basis. The memory may include volatile and/or non-volatile memory, and may be fixed or removable. Examples of suitable memory include recording media, random access memory (RAM), read-only memory (ROM), a hard drive, a flash memory, a thumb drive, a removable computer diskette, an optical disk or some combination thereof.

The memory 804 is a non-transitory device capable of storing information. One example of a suitable memory is a computer-readable storage medium, which is distinguishable from a computer-readable transmission medium capable of carrying information from one location to another. Examples of suitable computer-readable transmission media comprise electronic carrier signals, telecommunications signals, or some combination thereof. As used herein, the term “non-transitory” is a limitation of the medium itself (i.e., tangible, not a signal) as opposed to a limitation on data storage persistency (e.g., RAM versus ROM). A computer-readable medium as described herein generally refers to a computer-readable storage medium or computer-readable transmission medium. A computer-readable medium is any entity or device capable in which information, such as one or more computer programs or portions thereof, may be stored and carried.

In addition to the memory 804 (e.g., computer-readable storage medium), the processing circuitry 802 may also be connected to one or more interfaces for displaying, transmitting and/or receiving information. The interfaces may include a communications interface 808 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 810 and/or one or more user input interfaces 812. The display may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

Execution of the instructions 806 by the processing circuitry 802, or storage of the instructions in the memory 804, supports combinations of operations for implementing example implementations of the present disclosure. In this manner, an apparatus 800 may comprise at least one processing circuitry and at least one memory coupled to the at least one processing circuitry, where the at least one processing circuitry is configured to execute instructions stored in the at least one memory. It will also be understood that one or more functions, and combinations of functions, may be implemented by special purpose hardware-based computer systems and/or processing circuitry which perform the specified functions, or combinations of special purpose hardware and program code instructions.

Some example implementations of the present disclosure may also be carried out in the form of a computer process defined by one or more computer programs or portions thereof. Example implementations of the present disclosure may be carried out by executing at least one portion of a computer program comprising instructions. The computer program may be in source code form, object code form, or in some intermediate form. The computer program may be stored in a computer-readable medium that is readable by a computer, processing circuitry or other suitable apparatus. As indicated above, for example, the computer program may be stored in a memory, such as a computer-readable storage medium. Additionally or alternatively, for example, the computer program may be stored in a computer-readable transmission medium. The coding of software for carrying out example implementations of the present disclosure is well within the scope of a person of ordinary skill in the art.

As will be appreciated, any suitable instructions may be loaded onto a computer, a processor, a processing circuitry or other programmable apparatus from a memory or a computer-readable medium (e.g., computer-readable storage medium, computer-readable transmission medium) to produce a particular machine, such that the particular machine becomes a means for implementing the functions specified herein. The instructions may also be stored in a computer-readable medium that can direct a computer, a processor, a processing circuitry or other programmable apparatus to function in a particular manner to thereby generate a particular machine or particular article of manufacture. In some examples, the instructions stored in the computer-readable medium may produce an article of manufacture, where the article of manufacture becomes a means for implementing functions described herein. The instructions may be retrieved from a computer-readable medium and loaded into a computer, processor, processing circuitry or other programmable apparatus to configure the computer, processor, processing circuitry or other programmable apparatus to execute operations to be performed on or by the computer, processor, processing circuitry or other programmable apparatus.

Retrieval, loading and execution of instructions comprising program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor, processing circuitry or other programmable apparatus provide operations for implementing functions described herein.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a reporting configuration for reporting multipath channel measurements performed on a reference signal for positioning;
performing the multipath channel measurements on the reference signal for a reporting instance, the multipath channel measurements including a set of measurement samples for at least one time instance;
performing an evaluation of at least one of the multipath channel measurements relative to earlier multipath channel measurements for a preceding reporting instance, or measurement samples in the set of measurement samples; and
reporting, in the reporting instance based on the evaluation, an indication that the multipath channel measurements have at least a threshold similarity to the earlier multipath channel measurements, or a measurement report including a subset of the measurement samples.

2. The method of claim 1, wherein the method is performed by a transmission-reception point (TRP), and the reference signal is a sounding reference signal (SRS) transmitted by a user equipment (UE).

3. The method of claim 1 or claim 2, wherein the method is performed by a user equipment (UE), and the reference signal is a positioning reference signal (PRS) transmitted by a transmission-reception point (TRP).

4. The method of any of claims 1 to 3, wherein the evaluation indicates the multipath channel measurements have at least a threshold similarity to the earlier multipath channel measurements, and the indication is reported in the reporting instance without any measurement samples from the set of measurement samples.

5. The method of any of claims 1 to 4, wherein the evaluation indicates the multipath channel measurements do not have at least a threshold similarity to the earlier multipath channel measurements, and the measurement report including the subset of the measurement samples is reported in the reporting instance.

6. The method of claim 5, wherein the method further comprises:
selecting the subset of the measurement samples that is fewer in number than the set of the measurement samples; and
preparing the measurement report including the subset of the measurements.

7. The method of claim 6, wherein selecting the subset of the measurement samples includes for each measurement sample of at least some of the measurement samples:
calculating a sample value difference between values for the measurement sample and an earlier measurement sample from the earlier multipath channel measurements; and
selecting the measurement sample for the subset of the measurement samples when the sample value difference is greater than a threshold difference.

8. The method of any of claims 1 to 7, wherein the measurement report is reported, and the method further comprises performing a mapping of measured values for the measurement samples in the subset of the measurement samples to reported values for the measurement samples in the subset of the measurement samples, and
wherein the measurement report includes the reported values.

9. The method of any of claims 6 to 8, wherein the mapping is defined in a mapping table applicable to sample-based measurements including the measurement samples.

10. The method of any of claims 6 to 9, wherein the mapping is defined in a mapping table for path-based measurements which is extended to include sample-based measurements including the measurement samples.

11. A method comprising:
configuring a reporting entity with a reporting configuration for reporting multipath channel measurements performed on a reference signal for positioning, the measuring node configured to perform the multipath channel measurements on the reference signal for a reporting instance, the multipath channel measurements including a set of measurement samples for at least one time instance;
receiving from the reporting entity an indication that the multipath channel measurements have at least a threshold similarity to earlier multipath channel measurements for a preceding reporting instance, or a measurement report including a subset of the measurement samples;
recovering the multipath channel measurements for the reporting instance based on the indication or the measurement report; and
performing an evaluation of the reporting configuration based on the multipath channel measurements as recovered.

12. The method of claim 11, wherein the reporting entity is a transmission-reception point (TRP), and the reference signal is a sounding reference signal (SRS) transmitted by a user equipment (UE).

13. The method of claim 11 or claim 12, wherein the reporting entity is a user equipment (UE), and the reference signal is a positioning reference signal (PRS) transmitted by a transmission-reception point (TRP).

14. The method of any of claims 11 to 13, wherein the indication that the multipath channel measurements have at least the threshold similarity to earlier multipath channel measurements is received, and the multipath channel measurements are recovered based on the earlier multipath channel measurements.

15. The method of any of claims 11 to 14, wherein the measurement report is received, and the multipath channel measurements are recovered based on the subset of the measurement samples in the measurement report, and earlier measurement samples from the earlier multipath channel measurements.

16. The method of any of claims 11 to 15, wherein the measurement report is received, and the measurement report includes reported values for the measurement samples in the subset of the measurement samples, the reported values mapped from a mapping of measured values for the measurement samples in the subset of the measurement samples.

17. The method of claim 16, wherein the mapping is defined in a mapping table applicable to sample-based measurements including the measurement samples.

18. The method of claim 16 or claim 17, wherein the mapping is defined in a mapping table for path-based measurements which is extended to include sample-based measurements including the measurement samples.

19. The method of any of claims 11 to 18, wherein the reporting entity is located at a reference location, and performing the evaluation comprises:
determining a location of the reporting entity based on the multipath channel measurements as recovered;
performing a comparison of the location of the reporting entity and the reference location; and
performing the evaluation of the reporting configuration based on the comparison.

20. The method of any of claims 11 to 19, wherein the method further comprises:
performing an update to the reporting configuration based on the evaluation; and
configuring the reporting entity with the update to the reporting configuration.

21. An apparatus comprising:
at least one memory configured to store instructions; and
at least one processing circuitry configured to access the at least one memory, and execute the instructions to cause the apparatus to perform the method of any of claims 1 to 20.

22. An apparatus comprising means for performing the method of any of claims 1 to 20.

23. A computer-readable medium comprising instructions that, in response to execution by at least one processing circuitry, causes an apparatus to perform the method of any of claims 1 to 20.

24. A computer-readable storage medium comprising instructions that, in response to execution by at least one processing circuitry, causes an apparatus to perform the method of any of claims 1 to 20.

25. A computer program comprising instructions that, in response to execution by at least one processing circuitry, causes an apparatus to perform the method of any of claims 1 to 20.
